(19) United States
(12) Patent Application Publication
(10) Pub. No.: US 2024/0228133 A1
(43) Pub. Date: Jul. 11, 2024

(54) CONCENTRATE REFILL CLOSURE

(71) Applicant: MAYNARD & HARRIS PLASTICS, Rushden, Northamptonshire (GB)

(72) Inventors: Vikki WHITE, Rushden, Northamptonshire (GB); Roger MORRIS, Rushden, Northamptonshire (GB)

(21) Appl. No.: 18/559,441

(22) PCT Filed: May 10, 2022
(86) PCT No.: PCT/EP2022/062709

§ 371 Date: Nov. 7, 2023

(30) Foreign Application Priority Data
May 10, 2021 (GB) 2106606.3

(51) Int. Cl. B65D 47/36; B05B 11/00; B65D 81/32

(52) U.S. Cl. CPC B65D 47/36; B05B 11/0097; B65D 81/3211

(57) ABSTRACT

A refill cap is provided and comprises a body and a breaching member. The body includes connection means for connection to a refill container and the body can simultaneously be joined to a recipient container. The body further comprises an interior partition which prevents product flow through the body. The breaching member is movable to breach the partition whereby product can flow from a refill container into a recipient container via the cap.

The present invention relates generally to a closure and particularly, although not exclusively, to a closure for transferring concentrate liquid to a reusable container.

Refillable products are growing in popularity and their environmental benefits are clear. The need to transfer concentrates into reusable containers, for example, is driven by demand for a more sustainable alternative than large, single use packs with non-recyclable dispensers (such as a trigger spray).

Known refillable products typically involve a process of removing a closure or seal and then pouring or otherwise manually transferring the liquid. Having to remove a closure/seal to pour or transfer the liquid manually risks spillage and many concentrates pose greater risk than diluted, ready-to-use equivalents.

The present invention seeks to provide improvements in or relating to refilling.

An aspect of the present invention provides a refill cap comprising a body and a breaching member, the body includes connection means for connection to a refill container and the body can simultaneously be joined to a recipient container, the body further comprises an interior partition which prevents product flow through the body, the breaching member is movable to breach the partition whereby product can flow from a refill container into a recipient container via the cap.

Some embodiments provide or relate to a cap which can be used for a concentrate refill pack.

The present invention can provide sustainability; enabling multiple reuses of larger primary packs.

The closure may be applied to liquid products which can be commercialised as a concentrate for end users to dilute at home into empty, reusable packs. This may be for products which require non-recyclable dispensers (such as trigger sprays) which can be used again and again. Household cleaning or gardening products could be such examples.

Some embodiments relate, for example, to the transfer of concentrated liquid from a small refill bottle to an empty reusable bottle in a quick, efficient and intuitive way, which minimises potential exposure of the consumer to the concentrate.

In some embodiments the breaching member may be formed separately to the body and is attached or attachable thereto. The breaching member may be formed as an insert, for example.

The cap may be pre-assembled.

Some embodiments provide a two-piece (assembled) closure. It may, for example, comprise an outer threaded cap with a thin membrane area, and a movable insert snapped into place and held above the membrane.

In some embodiments the cap/closure, once applied to the bottle, may be non-removable due, for example, to ratchets below the neck which lock into the outer cap.

The connection means may be configured to non-removably connect the body to a refill container. Removable variants are also possible.

The partition may comprise a portion which is at least partially released upon breach. For example the portion may comprise a disc.

The portion may be frangibly connected in the partition. In some embodiments the portion is released from the body; in other embodiments the portion is partially released but remains tethered/fixed to the body.

The partition may comprise a conduit, such as a chimney/funnel/passage/tube, through which product can flow following breach. A chimney may be configured to become wedged in the partition upon breach, for example.

The breaching member may comprise radial ribs extending from the chimney on an upper and/or lower face.

The chimney may comprises one or more internal spokes. The spoke/s may function to prevent release of a partition portion (the portion cannot pass through the chimney).

In some embodiments either or both ends of the chimney are provided with one or more indentations and/or flow apertures.

In some embodiments the breaching member may be formed as an insert that can fit and function either way up, which makes for easier assembly.

The breaching member may be axially symmetrical; in some embodiments this means the member can be assembled into the body in either orientation.

The body may be generally (circular) cylindrical.

The breaching member may be slidably received in the body so that it can move or be moved axially therewithin.

The breaching member may be configured to function as one or more of: a piercing member; a rupturing member; a pushing member; a tearing member; a breaking member; an opening member.

In the unbreached/unopened condition the breaching member may be positioned/located on a recipient container side of the partition.

The body may have a retaining bead to prevent breaching member removal after assembly. The retaining bead may, for example, be positioned at or towards one end of the body. The bead may be a continuous annulus or segmented and may project radially inwards from the interior of a body sidewall.

The breaching member may be sealingly received in the body. For example a bore seal may be formed when the piercing member insert and the body are assembled together.

The body may be sealingly received on a refill container, for example using a bore seal (avoiding the need for a sealing wad, for example).

Some embodiments may be based on a push down principle; a screw down approach may alternatively or additionally be used.

The breaching member may be moved to breach the partition by force generated through movement of the cap relative to the recipient container. Force may, for example, be generated by generally axial pressure applied by a user. Alternatively or additional the body can be screwed down onto a recipient container to generate at least part of the breaching force.

A recipient bottle neck (of the correct size range) can successfully engage with the breaching member insert to push it through the partition (e.g. membrane) in such a way that liquid is channelled through the hole left behind.

Some aspects and embodiments could be thought of as an adapter for connecting a (concentrate) refill container to a recipient container.

An example of how some embodiments of the present invention function may be as follows:
1. User inverts refill pack and aligns over neck of empty reusable bottle.
2. Refill pack is pushed down.
3. Neck of reusable bottle makes contact with movable insert and pushes it towards the thin membrane.
4. A small amount of pressure is needed for the insert to break through the membrane with an audible ‘click.’ Liquid can freely flow from the refill bottle to the empty bottle via the funnel in the insert.

The present invention also provides a refill bottle for liquid concentrate.

The present invention also provides a cap as described herein in combination with a refill container.

The present invention also provides a concentrate refill pack.

The present invention also provides a refill pack comprising a refill container filled with concentrated liquid and a cap as described herein attached thereto.

The refill container may have a non-circular section.

An oval shape refill bottle may, for example, be better than round/circular for recyclability in term of compressibility and may help prevent it rolling around on a recycling conveyer belt, making it easier to sort from other items.

In some embodiments the pack is mono-material; for example the refill container, the body and the insert may be formed from polyethylene or polypropylene.

A plastics material such as polypropylene (PP) may be used for a cap and/or insert of a closure. This or other materials may be used depending on certain criteria, for example how easily a partition/membrane needs to be to break.

Different aspects and embodiments of the invention may be used separately or together.

The present invention will now be more particularly described, by way of example, with reference to the accompanying drawings.

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

In the following description, all orientational terms, such as upper, lower, radially and axially, are used in relation to the drawings and should not be interpreted as limiting on the invention.

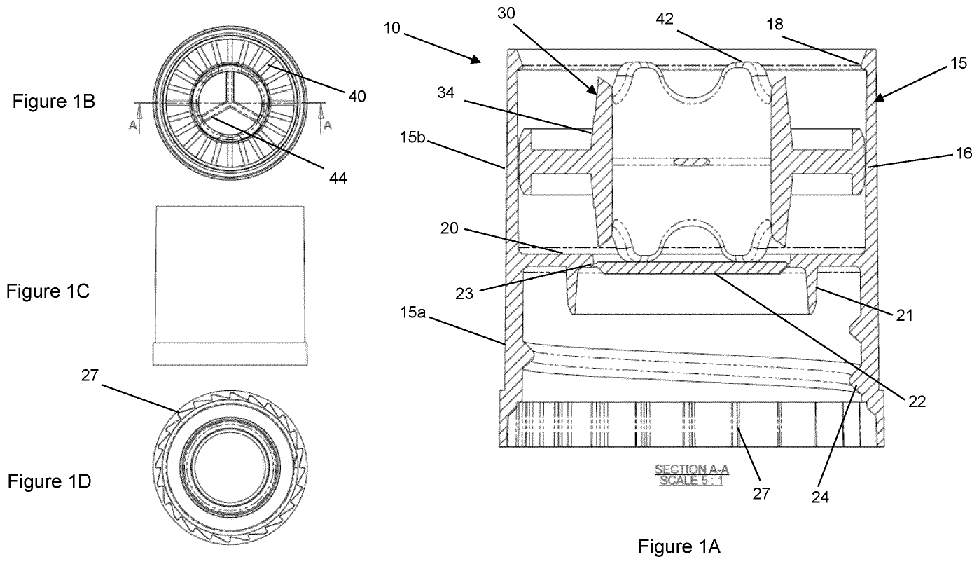

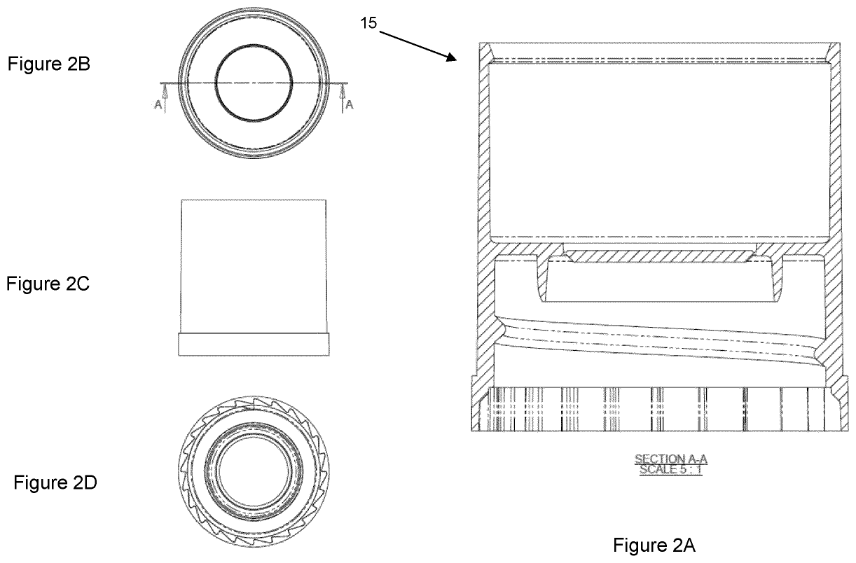

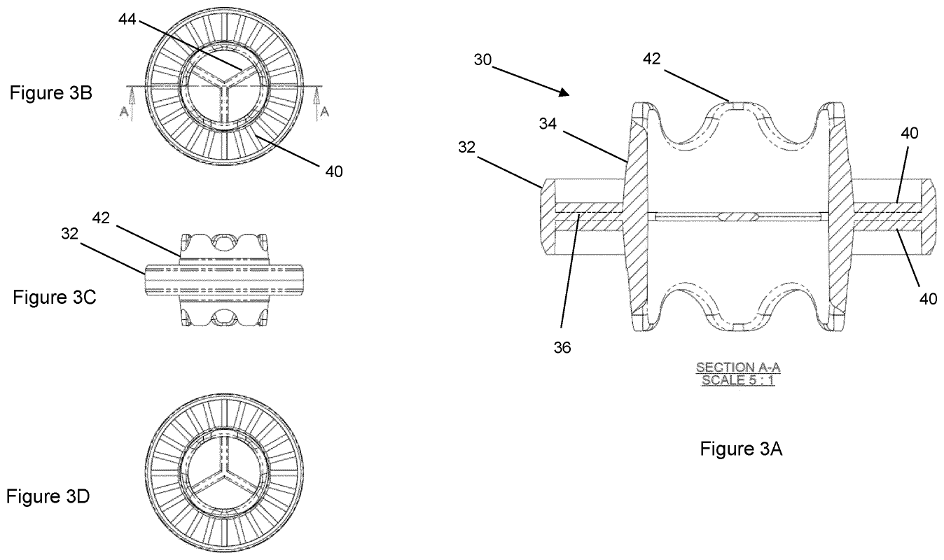

Referring first to FIG. 1 there is shown a two-piece assembled refill closure cap generally indicated 10. The closure 10 comprises an outer threaded cap body 15 (also see FIG. 2) with a partition 20 including a thin membrane area 23, and a movable insert 30 (also see FIG. 3) snapped into place and held above the membrane 23.

The body 15 comprises a generally cylindrical sidewall 16. The partition 20 extends laterally across the interior of the sidewall 16, approximately half way along in this embodiment. The partition 20 divides the body 15 into a lower, refill container-engaging side 15a and an upper, recipient container-engaging side 15b.

The partition 20 includes a central break disc 22 attached by the thinned membrane 23. In use, the movable insert 30 (or “breaching member”) functions as a piercer to pierce the membrane 23 by way of breaking the disc 22 away from the membrane 23.

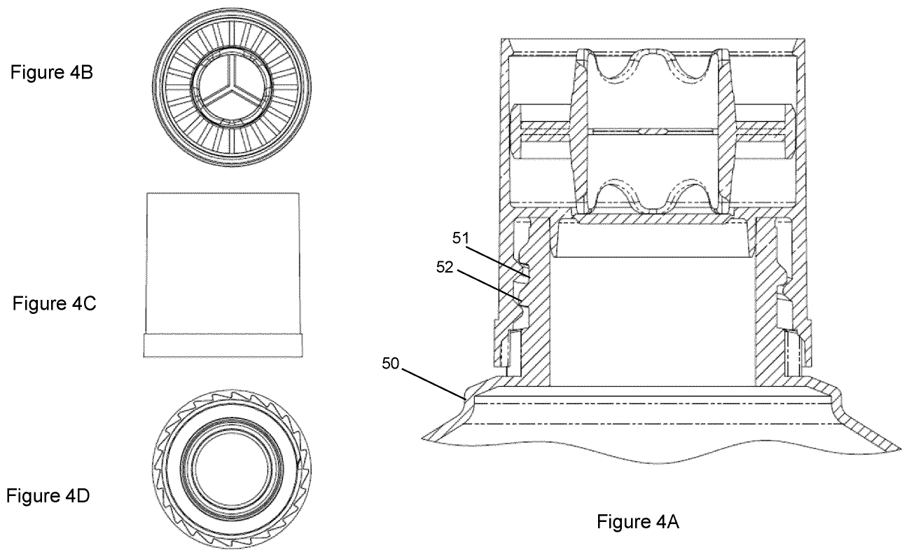

The partition 20 includes a depending annular sealing skirt 21 which extends around the membrane 23 (radially outward thereof) and into the side 15a. The sealing skirt 21 fits sealingly into the bore of a refill container (see FIG. 4), forming a bore seal and avoiding the requirement for a sealing wad.

The interior of the sidewall in the side 15a is provided with an internal screw thread formation 24 for engaging a cooperating formation 52 on the neck 51 of a refill container 50.

In this embodiment the closure, once applied to the bottle, is non-removable due to ratchets below the neck which lock into the outer cap.

The free end of the sidewall on the side 15a is provided with a plurality of ratchets 27 for engaging cooperating teeth 54 on a refill container 50 (see FIG. 4). The ratchets 27 prevent the cap being removed from the refill bottle. This ensures that the bottle contents can only be accessed by the instructed means and keeps bottle and closure together for recycling.

The free end of the sidewall at the side 15b is provided with an upper retaining bead 18 to prevent removal of the insert after assembly.

In this embodiment the insert 30 is formed as a breaching member. The insert 30 comprises a peripheral, axial, annular wall 32 and a central chimney 34 joined together by a lateral annulus 36. The upper and lower faces of the annulus 36 are provided with a plurality of radial ribs 40.

In use the radial ribs 40 on the upper face receive the neck of the recipient container and the recipient container neck pushes against them. The ribs also create a passage for air to travel through. The radial ribs on the lower face can act like cells to capture and hold any small amount of liquid which seeps past the piercer/broken membrane interface.

Each end of the chimney 34 is undulating, forming a plurality of projecting turrets 42 surrounding the central funnel for liquid to flow through.

In use the turrets 42 contact with the upper face of the break disc 22 to transfer vertical force. Fewer contact points or an angled funnel end may be used to concentrate the force on certain areas of the disc. Having a singular point of first contact may be used to encourage the disc to push aside after breakage.

Gaps between turrets 42 maximise product drainage. If the break disc 22 does not move aside and instead sits on the turrets when separated, liquid can still drain through.

The circular thin membrane 23 acts as a break point when vertical force is applied via the piercer. Force is created through vertical pressure applied by a user, or through a downwards screwing motion, for example.

The disc/membrane is broken through around the break point, allowing liquid to drain from the refill bottle. The disc/membrane will either break away fully, or a narrow strip may remain to tether the disc to the cap, such that it hinges out of the way as the piercer chimney passes through.

The chimney 34 includes spokes 44 across the central funnel. These prevent the break disc 22 from leaving the bottle once broken away, where it would risk not being captured in the recycling chain.

In use the chimney 34 moves into the neck bore of the receiving bottle.

In this embodiment the insert 30 is symmetrical for ease of assembly, but in other embodiments this is not the case (for example to help better secure the piercer in the upper cap).

This system can be used with any 28 mm neck, regardless of thread form, pitch, start, etc. Other embodiments can accommodate different sized necks.

Non-round refill bottle shapes may be used as they may be less likely to be lost in the recycling system (due to tendency to roll on conveyors).

In this embodiment the closure and refill bottle are formed as a mono material pack; this is better for recycling. The bottle and cap may both be either PP or PE, for example.

As discussed in more detail below, a bottle neck (of the correct size range) can successfully engage with the insert to push it through the membrane in such a way that liquid is channelled through the hole left behind.

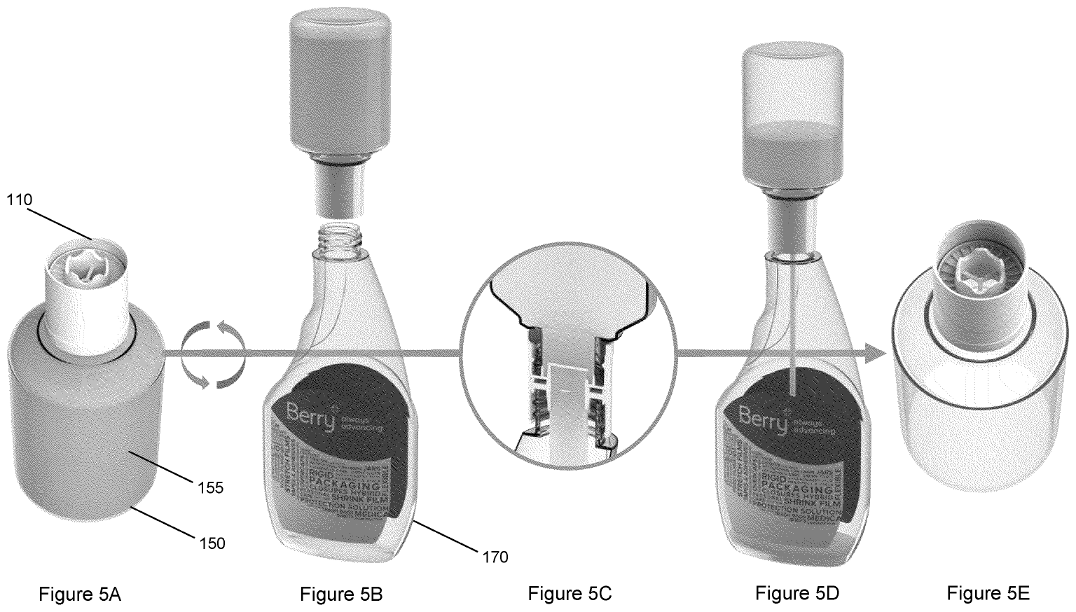

FIGS. 5A to 5E show a refill bottle 150 filled with concentrate 155, closed by a refill cap 110 and used with a recipient container 170.

### Assembly

Refill cap is a 2-part assembly—supplied assembled—whereby the piercer is snapped into the upper portion of the cap (piercer housing).
Once assembled, the piercer should be very difficult to remove. Piercer is currently symmetrical and can be assembled in either orientation, but this may change with future development.
Ratchets prevent the refill cap from being removed from the bottle after filling and capping process.

This cap can be used on various bottle options.

### Use

User unscrews and removes trigger (not shown) from an empty recipient bottle (e.g. with a 28 mm neck) which is to be refilled with a water and concentrate mix.
User fills empty trigger bottle with water to an instructed level.
User inverts the refill pack (cap down) and aligns the cap over the 28 mm trigger bottle neck. The refill cap is designed such that the piercer funnel fits into the bore of standard 28 mm necks, and the inner diameter of the piercer housing will not interfere with the thread crests of standard 28 mm necks.
Upper face of the trigger bottle's neck contacts with the radial ribs on the upper face of the piercer.
User applies a downwards force to the refill pack. The piercer transfers this force to the break disc.
In this embodiment this force would be created by pushing down on the refill bottle. Another possibility may be that the user must screw the refill pack down onto the trigger bottle neck, using a thread on the inner face of the piercer housing.
Thin membrane around the break disc snaps, which frees the central disc.
As piercer moves into the hole created, the break disc is pushed aside.
Concentrated liquid can now flow from the refill pack into the trigger bottle via the piercer's central funnel.
Outer face of the piercer funnel wedges into the hole created from removing the break disc, preventing liquid from passing around the outside of the funnel.
Concentrate drains from the refill bottle down into the trigger bottle below.
Seepage around the piercer/hole interface is captured by the piercer (in cells created by radial ribs on its underside) to reduce the likelihood of drips.
Concentrate can drain into the piercer funnel via gaps between turrets, giving a high degree of product drainage.
Once empty, the user can remove the refill pack from the trigger bottle. In the current design it is lifted away, but if a screwing system is developed it would need to be unscrewed.
Trigger is reapplied for reuse with refilled trigger bottle.
Empty refill bottle and cap can be recycled as one unit. Break disc is retained inside the pack—it is prevented from dropping out by branches across the piercer funnel.

### Technical Info

Pack is mono-material (PP or PE).
Break point may be between 0.1 mm and 0.2 mm thick
The vertical force required to break the disc may be between 7 kgf (15 lbf) and 19 kgf (42 lbf). A target force requirement may be be at the lower end of this range.
Pack purpose is to transfer a single dose of concentrated liquid into a receiving container without a user risking contact with the concentrate (mess-free, no drips).

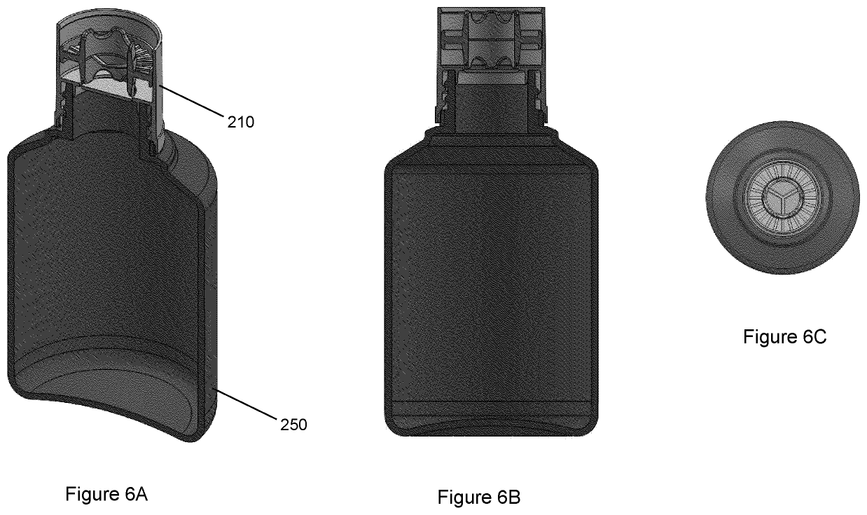

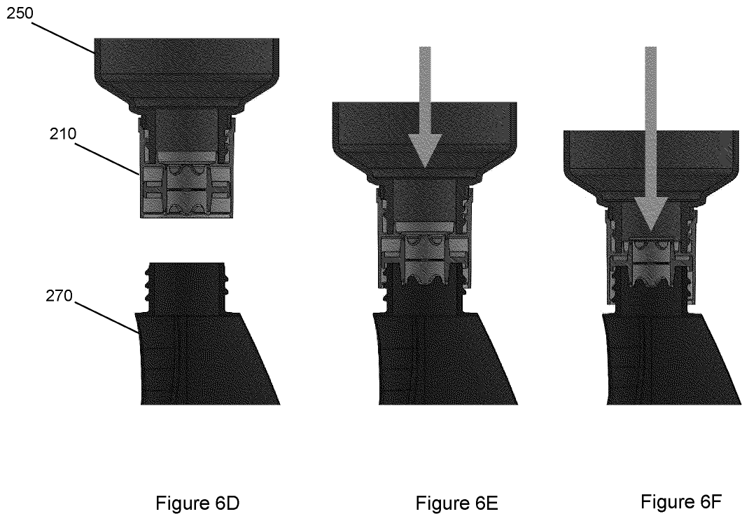

FIGS. 6A to 6C show a refill pack comprising a refill container 250 and a refill closure 210 formed according to a further embodiment. Use of the refill pack is described in relation to FIGS. 6D to 6F.

FIG. 6D—invert refill pack and align with neck of empty bottle.

FIG. 6E—bring refill pack down until bottle neck engages into the cap; press down until an audible click.

FIG. 6F—membrane is broken and product is dispensed; then the mono-material refill pack can be recycled.

Transferring concentrated liquid from a small refill bottle to an empty reusable bottle is thus achieved in a quick, efficient and intuitive way, which minimises potential exposure of the consumer to the concentrate. In contrast to the present invention, requiring a user to first remove a closure/seal to pour or transfer the liquid manually from a refill bottle risks spillage, and many concentrates pose greater risk than their than diluted, ready to use equivalents. The need to transfer concentrates in such a way is driven by demand for a more sustainable alternative than large, single use packs with non-recyclable dispensers such as a trigger sprays.

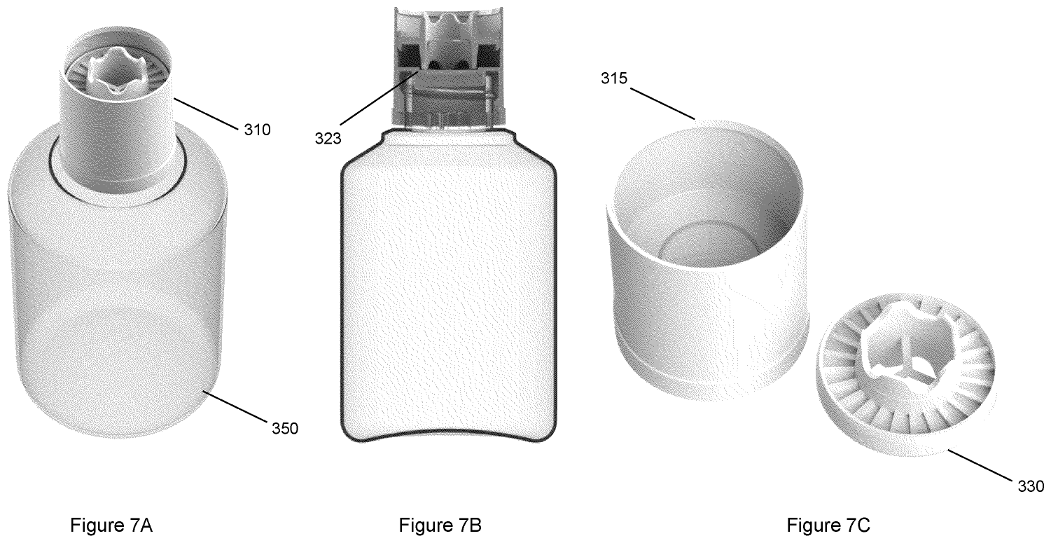

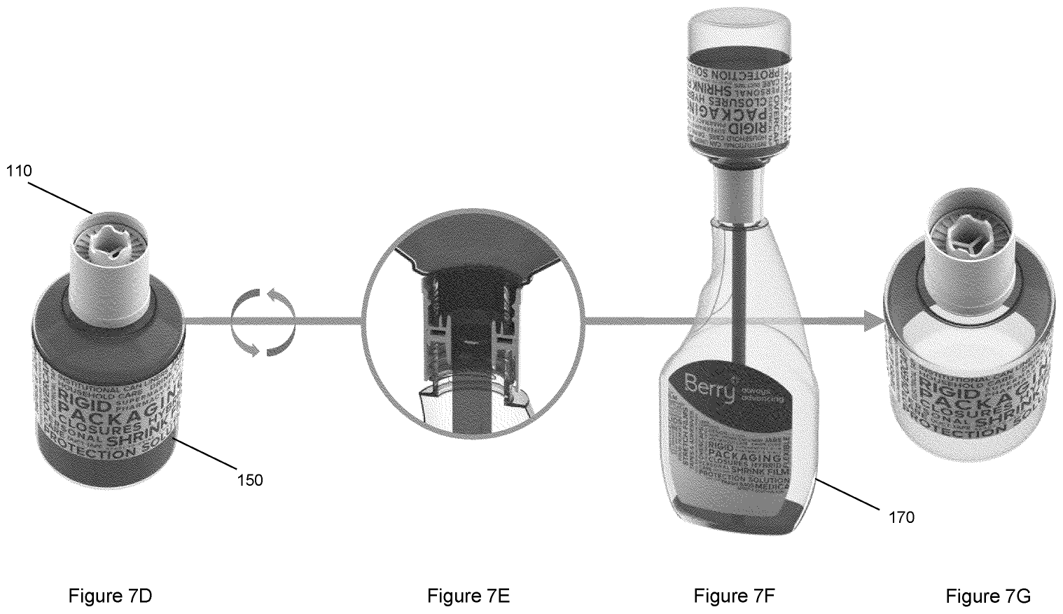

FIG. 7A to 7C show a further embodiment based on a two-piece cap 310 with a thin, breakable membrane 323. Operation of the pack is shown in FIGS. 7D to 7G.
1. User must first invert refill pack and align over neck of empty main bottle.
2. Push refill pack down until bottle neck engages.
3. A small amount of pressure is needed to break the membrane with an audible ‘click’.
4. Product can freely flow.
5. Once empty remove refill bottle from main bottle and attach original bottle trigger closure.

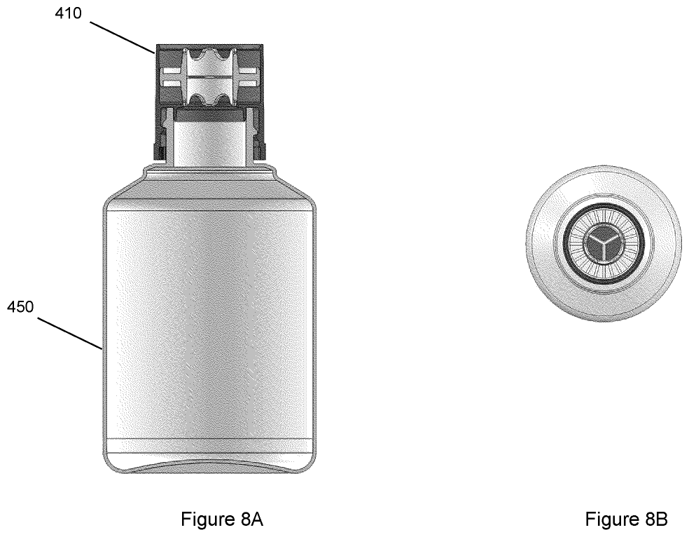

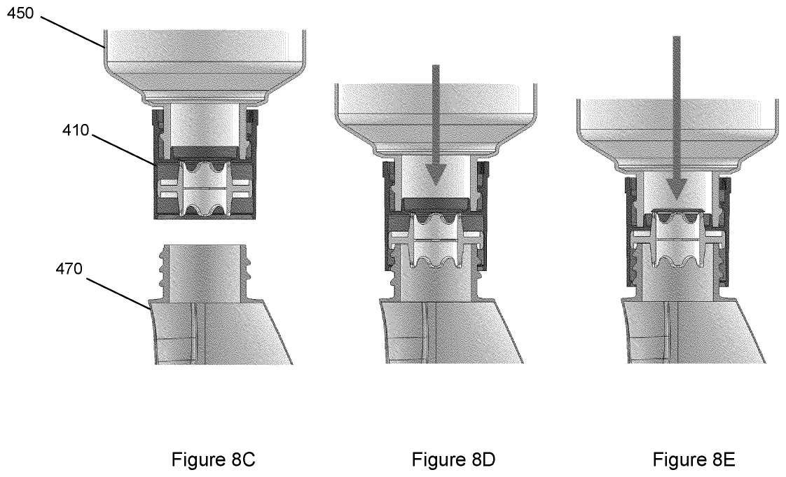

FIGS. 8A and 8B show a further embodiment based on a two-piece cap 410. Operation of the pack is shown in FIGS. 8C to 8E.
1. Invert refill pack and align with neck of empty bottle.
2. Bring refill pack down until bottle neck engages into the cap. Press down until you hear a click.
3. Membrane is broken and product is dispensed.
4. Remove and recycle mono-material refill pack.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention.

1-25. (canceled)

26. A refill cap comprising
a body and a breaching member, the body includes connection means for connection to a refill container and the body can simultaneously be joined to a recipient container, the body further comprises an interior partition which prevents product flow through the body, the breaching member is movable to breach the partition whereby product can flow from a refill container into a recipient container via the cap, in which the breaching member comprises a chimney through which product flows following breach,
wherein the breaching member comprises radial ribs extending from the chimney on an upper and/or lower face.

27. The refill cap of claim 26, in which the breaching member is formed separately to the body and is attached or attachable thereto.

28. The refill cap of claim 26, in which the connection means non-removably connect the body to a refill container.

29. The refill cap of claim 26, wherein the partition comprises a portion which is at least partially released upon breach.

30. The refill cap of claim 29, wherein the portion comprises a disc.

31. The refill cap of claim 29, wherein the portion is frangibly connected in the partition.

32. The refill cap of claim 26, wherein the chimney is configured to become wedged in the partition upon breach.

33. The refill cap of claim 26, wherein the chimney comprises one or more internal spokes.

34. The refill cap of claim 26, wherein either or both ends of the chimney are provided with one or more indentations and/or flow apertures.

35. The refill cap of claim 26, wherein the breaching member is axially symmetrical and can be assembled into the body in either orientation.

36. The refill cap of claim 26, in which the body is generally cylindrical.

37. The refill cap of claim 26, wherein the breaching member is slidably received in the body and can move or be moved axially therewithin.

38. The refill cap of claim 26, wherein the breaching member is one or more of: a piercing member; a rupturing member; a pushing member; a breaking member; an opening member.

39. The refill cap of claim 26, wherein the breaching member is positioned on a recipient container side of the partition.

40. The refill cap of claim 26, wherein the body has a retaining bead to prevent breaching member removal after assembly.

41. The refill cap of claim 26, wherein the breaching member is sealingly received in the body.

42. The refill cap of claim 26, wherein the breaching member is moved to breach the partition by force generated through movement of the cap relative to the recipient container.

43. The refill cap of claim 42, wherein force is generated by generally axial pressure applied by a user.

44. The refill cap of claim 42, wherein the body can be screwed down onto a recipient container to generate the breaching force.

45. The refill cap of claim 26 in combination with a refill container.

46. A refill pack comprising a refill container filled with concentrated liquid and the refill cap of claim 26.

47. The refill pack of claim 46, wherein the refill container has a non-circular section.

48. The refill pack of claim 46, wherein the refill pack is mono-material.
